(19) United States
(12) Patent Application Publication
(10) Pub. No.: US 2015/0193817 A1
(43) Pub. Date: Jul. 9, 2015

(54) METHOD AND APPARATUS FOR GENERATING AN INTELLIGENT ADVERTISEMENT

(71) Applicant: GoldSpot Media Inc., Sunnyvale, CA (US)

(72) Inventor: Srini Dharmaji, Cupertino, CA (US)

(73) Assignee: GoldSpot Media Inc., Sunnyvale, CA (US)

(21) Appl. No.: 14/149,680

(22) Filed: Jan. 7, 2014

(51) Int. Cl. G06Q 30/02

(52) U.S. Cl. CPC G06Q 30/0246; G06Q 30/0273

(57) ABSTRACT

A method of generating intelligent advertisements starts by receiving an advertisement (“ad”), a viewability criteria associated with the ad and a payment criteria associated with the ad. An intelligent component is then defined and generated based on the type of ad, the ad viewability criteria, and the ad completion criteria for payment (payment criteria). The intelligent component is then incorporated into the ad itself, to generate an intelligent ad. The intelligent component includes instructions that when executed on a web page, causes the instantiation of an intelligence associated with the ad, on the web page that enable registration of an impression of the intelligent ad only when the viewability criteria and the payment criteria are met. Other embodiments are also described.

### FIELD

Embodiments of the invention relate generally to optimization of measurement and charging for displayed and viewed advertisements and interactive content.

### BACKGROUND

When the advertisements (“ads”) are presented to the consumer on a web page, one of the problems faced by advertisers is the problem of appropriately measuring the ad viewing (e.g., the number of ads viewed) by the consumers such that the advertisers are paying for the viewed ads accordingly. Currently, advertisers are paying for ads by the impressions or by the interactions. Today, since the capability to measure viewability is lacking, an impression for which payment is due is considered to be the loading of a web page with the ad on the display. In other words, once a web page is loaded by a mobile device and the webpage includes the ad, the ad is thus considered to be an impression. This leaves a lot to be desired as the ad that is loaded may be below the fold and unless the consumer scroll down the web page the ad remains invisible to the consumer. Referring to FIG. 1, a device displaying a portion of a loaded page in accordance with a prior art system is illustrated. In FIG. 1, this feature of visibility on a web page 103 that is loaded on a display device having a display screen 101 with a display area 102 is shown. The loaded web page 103 is visible to the customer above the fold-line 104 while there is no visibility to items on the web page 103 loaded below the fold line 104. Even if the ads 111-115 are not visible to the consumer, the ads 110 to 115 on the loaded web page 103 are all counted as active payable impressions.

FIG. 4 illustrates a prior art system for delivering an ad and requesting the payment for the impressions. The advertiser 402 uses an ad server 410 to generate the ad for a campaign. The advertiser 402 then supplies the ad to the publisher 403 either directly or via the ad exchange 404. The publisher 403 delivers the ad included in a web page 103 to the display device 401. When the web page 103 is loaded, a portion of the web page is visible on the display screen 101 and the rest of the web page is below the fold line 104 such that it is invisible to the customer until he scrolls down the web page using the input devices on the device 401. In most cases, the user does not scroll down the web page such that only the ads that are displayed on the display screen 101 when the web page is loaded are seen. However, since the web page has completely loaded on the display device 401, that information is fed back to the publisher 405 and an impression is registered for each ad on the loaded page whether on screen 101 or below the fold line 104. The number of impressions are then counted and used to invoice 406 the advertiser for payment.

Another problem arises when animations or flash ads and video ads (rich media ads) are displayed below the fold line 104 because the ad starts the animation, flash or video as soon as the animation, flash or video is loaded. For instance, the typical animation duration is of the order of 15 seconds such that by the time the customer scrolls to the portion of the web page that includes the ad, the animation will have completed and the only visible part of the mobile ad seen is the last static page of the rich media ad. However, since the page with the rich media ad has loaded, the advertiser has to pay for the rich media ad even though the consumer has not seen the whole ad.

The Internet Architecture board (IAB) has introduced a standard “making measurements make sense” or 3MS that covers the requirements for considering an ad as viewed under the ad unit guidelines. The standard mandates a viewability criteria that at least 50% of the pixels of each ad frame of the ad should be viewed to consider the ad as seen or to consider it as an impression. It will be of advantage to the advertiser to have a capability to identify as impressions only the ads that have met the viewability criteria set, that is, at least a pre-defined percentage of the pixels (e.g., currently at least 50% of their pixels) are visible to the consumer, in each frame of the ad, are identified as impressions. Thereby enabling the advertiser to pay only for the ads that have been seen by the consumer.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. In the drawings:

FIG. 1 illustrates a device displaying a portion of a loaded page in accordance with a prior art system.

FIG. 2 illustrates a block diagram of an intelligence component being added to an advertisement (“ad”) to create an intelligent ad according to one embodiment of the invention.

FIGS. 3A and 3B illustrate a device displaying a portion of a loaded page where the added intelligence from the intelligence component executed on a web page recognizes that the ad frame does not meet the viewability criteria and hence does not register an impression (FIG. 3A) and a device displaying a portion of a loaded page where the added intelligence from the intelligence component recognizes that the ad frame meets the viewability criteria and hence enables registration of an impression (FIG. 3B) according to one embodiment of the invention.

FIG. 4 illustrates a prior art system for delivering advertisement and requesting the payment for the impressions.

FIG. 5 illustrates a system generating an intelligent ad to recognize, monitor and measure the viewing of the ad based on a viewability criteria and provide the registered impression counts to the advertiser for which payment is due according to one embodiment of the invention.

FIG. 6 illustrates an ad modifying server included in the system for the generation of the intelligent ad (or intelligent mobile ad), according to one embodiment of the invention.

FIG. 7 illustrates a device included in the system to execute the intelligence included in the intelligent ad to ensure that only the executions or displays of the intelligent ad that meet the terms of viewability criteria are counted as impressions according to one embodiment of the invention.

FIG. 8 illustrates a flow diagram of an example method of generating an intelligent ad according to one embodiment of the invention.

FIG. 9 illustrates a flow diagram of an example method of registering impressions on a loaded web page with an intelligent static ad when payment is based on cost per ad view and providing the registered impressions count according to one embodiment of the invention.

FIG. 10 illustrates a flow diagram of an example method of registering impressions on a loaded web page with an intelligent rich-media mobile ad when payment is based on cost per completed view and providing the registered impressions count according to one embodiment of the invention.

FIG. 11 illustrates a flow diagram of an example method of registering impressions on a loaded web page with an intelligent rich-media mobile ad when payment is based on cost per engagement and providing the registered impressions count according to one embodiment of the invention.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

In the description, certain terminology is used to describe features of the invention. For example, in certain situations, the terms “component,” “unit,” “module,” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic. An example of “software” includes executable code in the form of an application, an applet, a script, a routine or even a series of instructions. The software may be stored in any type of machine-readable medium.

According to one embodiment, a method is disclosed that allow the advertisers to measure and pay for advertisement impressions displayed on web sites, whether over or under the fold based on visibility criteria established, as percentage of visible pixels of an ad, by the internet architecture board standard called “making measurements make sense” or 3MS. The 3MS standard defines an advertisement impression as one where at least 50% of the pixels are visible to the consumer. In one embodiment, the method disclosed provides built-in viewability intelligence within the ad, in the form of executable software, associated with the ad and transferred to the display system as metadata with the ad, typically as an ad-tag that can be run on the web page, to enable reporting of viewed impressions back to advertiser. The ad-tag also called intelligent component, generally in the form of a script, adds the capability or intelligence to check and verify pre-established ad viewability criteria and ad completion criteria. Further, the terms ad-tag, Intelligent-tag, Intelligence-tag, Intelligent component and Intelligence component all have the same meaning within the specification provided.

Accordingly, embodiments of the invention relate to introducing intelligence into the advertisements generated such that the intelligence included in an intelligent ad is able to recognize when the ad is being viewed on the web page. For instance, the intelligence instantiated (I-Intelligence) on the web page when the ad-tag is executed on the web page from the intelligent ad may recognize that the ad is being viewed when more than a pre-defined percentage of the pixels of the ad are visible on the display screen of a device. Thus, the viewability criteria may be set as a pre-defined percentage of pixels being visible on the display. The I-Intelligence when intelligent ad is executed on the web page is therefore able to generate the information regarding impressions based on the viewability criteria that is established. The number of impressions of an ad may be calculated and then transmitted to the publisher and advertiser for reconciling and payment of the viewed ads.

In the case of the rich media ads, there is a requirement that the viewability criteria of each frame of the ad is met and the ad completion criteria (payment criteria) is met for the ad to be considered for registering an impression for payment. The I-Intelligence from the intelligent ad is able to recognize when more than the pre-defined percentage of the pixels on any frame are visible on the web page display and generate a signal for starting the animation or video. When less than that percentage of the frame is visible on the display, that is when the viewability criteria on a frame is not met, the animation is stopped or paused until such time the viewability criteria is met. The completion of the animation is also recognized by the I-Intelligence as a criteria for generating an impression of the rich media ad. The completion based on the payment criteria, that is either a visible last static page or viewable display of an engagement page, causes an impression to be registered. The count of such impressions over a period of time are then provided to the publisher and advertiser for reconciliation and payment.

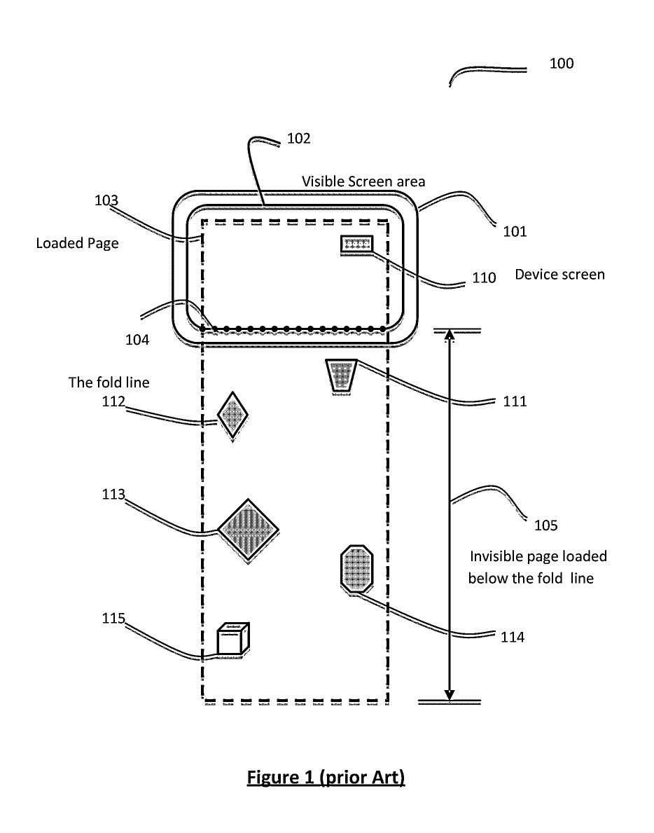

FIG. 1 illustrates a device displaying a portion of a loaded page in accordance with a prior art system. The web page 103 is loaded for viewing on the display device. The ad 110 is displayed in the visible region of the display (e.g., device screen 101) while the other ads 111-115 are invisible to the customer at the time of web page load. Nonetheless, the ads 110-115 are all counted as impressions and the advertiser is required to pay for all the ads that are on the loaded web page including those ads not seen by the customer.

In the embodiments of the invention, the ads 111 to 115 which are below the fold line 104 and not visible to the consumer are not considered impressions even though they are all on the loaded page. The ads are considered as impressions only if a predefined threshold of pixels of the frame (e.g., over 50% of their pixels per the IAB-3MS standard) are visible (e.g., above the fold line 104).

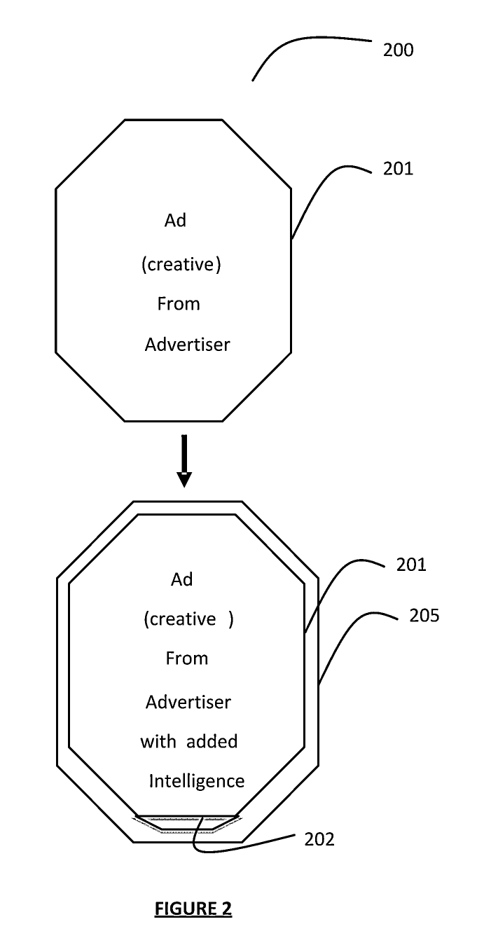

FIG. 2 illustrates a block diagram of an intelligence component or ad-tag being added to a static ad to create an intelligent ad according to one embodiment of the invention. The intelligent ad that is generated enables this process of including the viewability criteria into the ad. In FIG. 2, diagram 200 shows the conversion of an ad 201 to an intelligent ad 205 by adding at least a viewability criteria checking and information transfer component 202 (“intelligence component”).

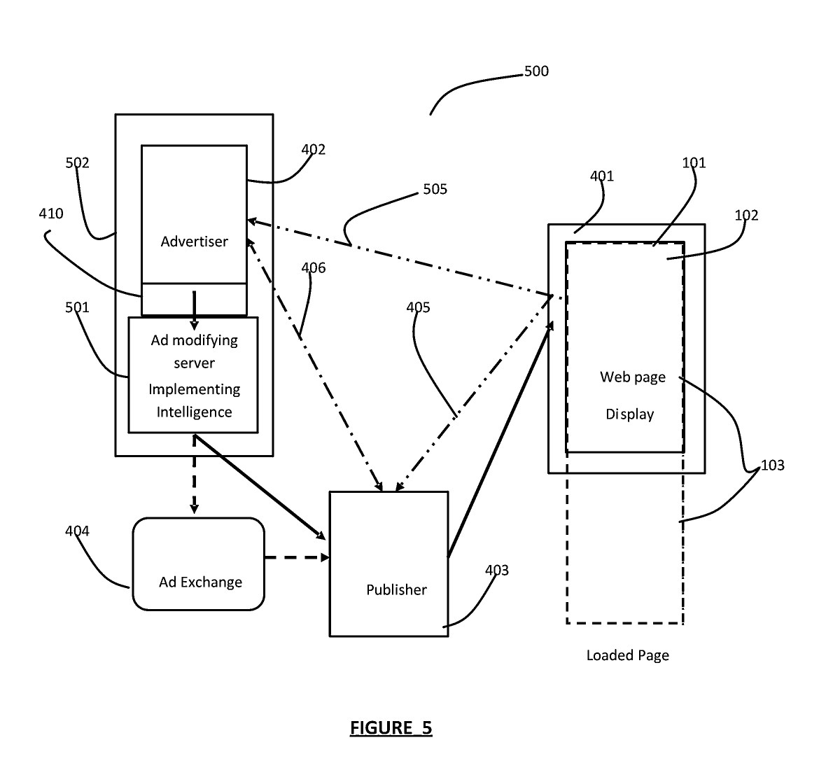

FIG. 5 illustrates a system 500 generating a static ad that is an intelligent ad that is able to instantiate an intelligence (I-Intelligence) on a loaded web page to recognize, monitor and measure the viewing of the ad and provide the registered impression counts to the advertiser for which payment is due according to one embodiment of the invention.

The advertiser 402 uses an ad generator and server 410 to generate the ad 201 for a campaign. This ad is then converted to the intelligent ad 205 by the ad modifier 501 by adding the necessary intelligence component 202 to the ad 201. The intelligent ad is hence a combination of the ad supplied by the advertiser modified to include the intelligence component 202, typically as an ad-tag or intelligent-tag within the ad. In one embodiment, the intelligent ad generation is performed by the intelligent ad generation system 502 that includes the advertiser 402, the server 410, and the ad modifier 501. The intelligent ad 205 is then provided from the intelligent ad generation system 502 to the publisher 403 directly or through the ad exchange 404. The publisher 403 (which may include a publisher server) enables the intelligent ad 205 to be supplied as ad metadata to be loaded on the web page 103 on the display screens of the chosen display devices either in the visible display area 102 or below the fold line 104 in the invisible area 105 of the web page 103. If the ad loaded in the visible display area 102 where more than pre-defined percentage of pixels (e.g., at least 50% of the pixels as per IAB-3MS standard) of the intelligent ad 205 is visible, then it is immediately registered as an impression. In cases where the intelligent ad 205 is below the fold line 104 or if only less than the pre-defined percentage (e.g., 50% of the pixels as per the IAB-3MS standard) of the ad 205 is visible above the fold line 104, the intelligence component 202 executed on the web page instantiates an intelligence (I-Intelligence) on the web page and associates with the ad to recognize that the intelligent ad 205 has not been seen by the customer. Hence, the ad 205 on the web page is not registered as an impression. If the customer scrolls down the web page such that at any time more than the pre-defined percentage of the pixels of the intelligent ad 205 becomes visible (102) on the display screen 101, the I-Intelligence recognizes the intelligent ad 205 has been seen by the customer and registers it at that time as an impression. Once the impressions have been registered, the impressions count is passed on to the advertiser 402 and the publisher 403 for consolidation reconciliation and payment.

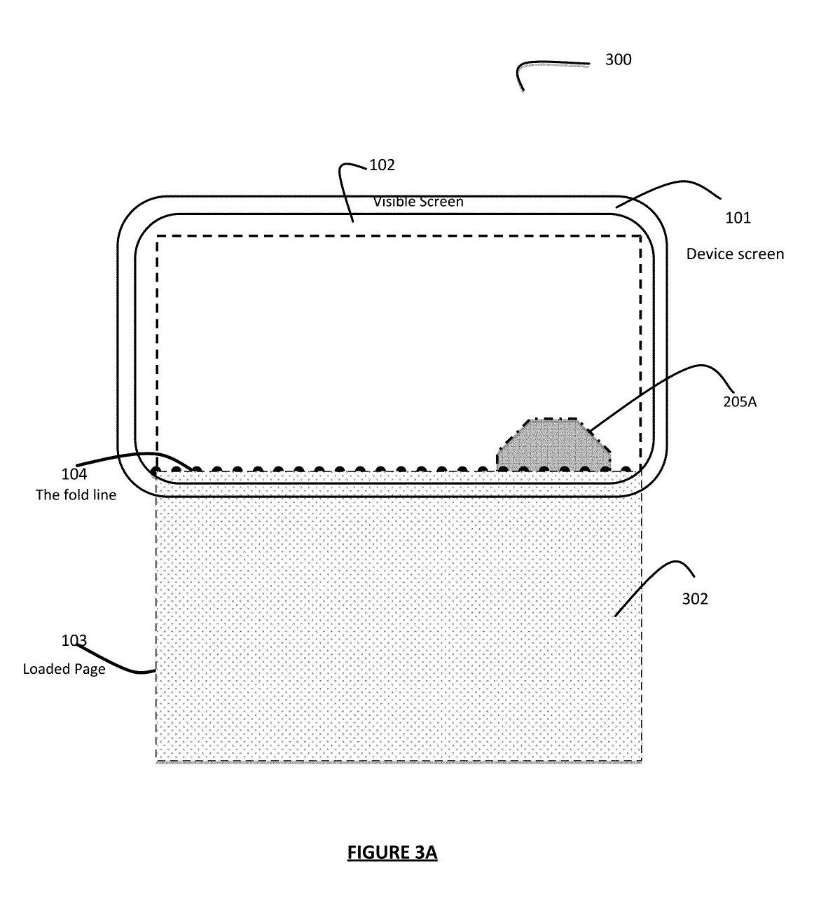

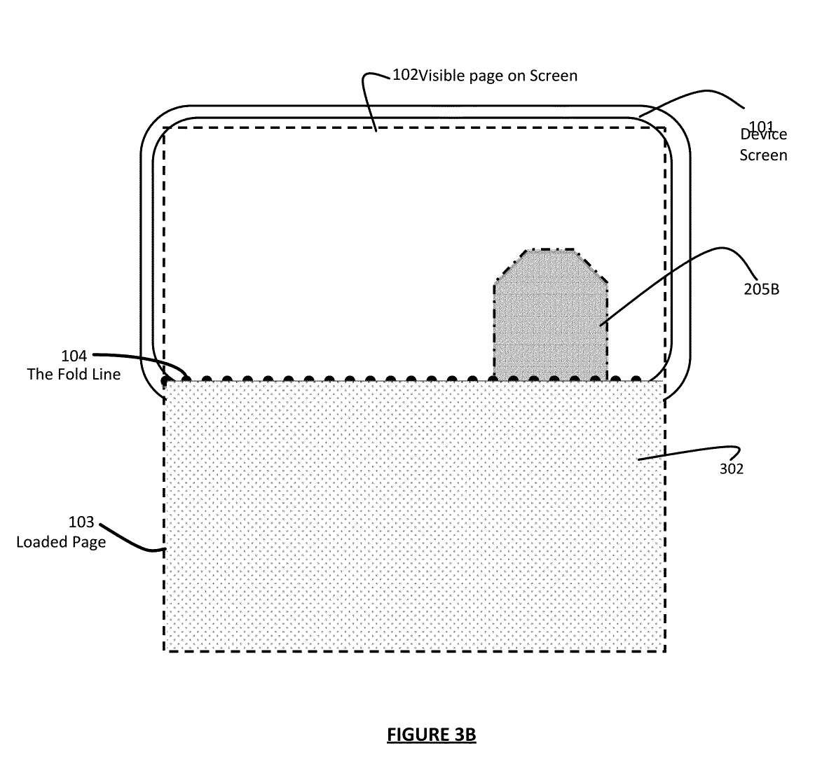

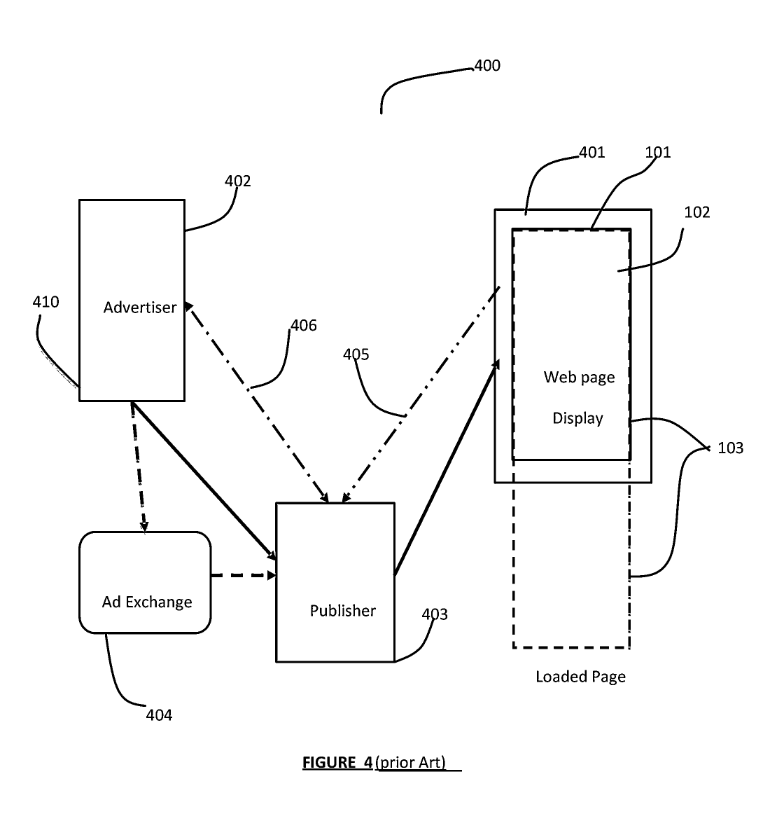

FIGS. 3A and 3B illustrate a device displaying a portion of a loaded page where the I-Intelligence associated with the intelligent ad 205A on the web page 103 does not register an impression (FIG. 3A) and a device displaying a portion of a loaded page where the I-Intelligence associated with the intelligent ad 205B on the web page 103 enables registration of an impression (FIG. 3B) according to one embodiment of the invention. The basic operation of the added I-Intelligence associated with an intelligent ad 205 (Figures A-B) instantiated on the loaded web page 103 from the intelligence component 202 is shown using the block diagram 300 in FIGS. 3A and 3B. The following description uses as an example the IAB-3MS standard of 50% of pixels being made visible to establish viewability as a reference. FIG. 3A shows the intelligent ad 205A being exposed on the visible region 102 of the device display screen 101 by an amount which displays less than 50% of the pixels of the ad 205A. Accordingly, the majority of the intelligent ad 205A is below the fold line 104 and is in the non-displayed region 302 of the loaded web page 103. In this case the I-Intelligence recognizes that the viewability is less than 50% and does not register an impression for the ad 205A. FIG. 3B shows the intelligent ad 205B on the loaded web page 103 as displayed on the visible display screen 102 after the consumer scrolls further down the web page. The intelligent ad 205B has more than the predefined percentage (e.g., Over 50%) of its pixels visible on the device display screen 101 and thus, the I-Intelligence associated with the intelligent ad 205B generates a signal registering the ad as an impression for payment.

The I-Intelligence associated with the intelligent ads 205 improve the capability to define payment terms by the advertiser 402 by implementing the viewability intelligence component 202 to determine when an ad has been viewed by the consumer. Accordingly, this determination is moved from the publisher 403 (including ad exchanges 404) to the advertiser 402, enabling the advertiser to ensure the viewing of the ad by the consumer prior to payment for impressions.

In accordance with embodiments of the invention, the intelligent ads may be used to affect the registrations of impressions in at least three ways. These three ways relate to three types of ads used in practice and payment terms established for the ad viewed on the webpages. The intelligent ads take into account what constitutes completion of an ad display in enabling registration of an impression for payment. The three ways the intelligent ads affect the registrations of impressions for payment include:

1. Cost per ad view: In this scheme the ads are static ads and payment for completed ads are as described above. That is, any ad delivered is paid for only when a predefined and agreed on percentage of its pixels are made visible to the consumer on the display screen. In this case, the frame viewability criteria (e.g., 50% of the pixels of the ad) has to be met before it is counted and registered as an impression.

2. Cost per completed view: This is applicable to ads which are rich-media ads (or animation ads) such as video ads and flash ads. The advertiser is provided an impression feedback only when the whole ad is considered to have been seen by the consumer in accordance with the viewability criteria established. For instance, when each frame of the ad including the last frame of the ad is completed as per the viewability criteria set (e.g., 50% of the video ad's pixels are visible), an ad complete message (that may be in the form of a registered impression for the rich media ad) is generated by the I-Intelligence on the web page from the execution of the intelligent component 202 associated with the intelligent ad, and sent to the advertiser and the publisher for reconciliation and payment processing. In this case, if at any point during the intelligent ad viewing by the consumer, the viewability criteria is negated (e.g., less than 50% of the video ad's pixels are visible), the display of the intelligent ad is stopped by the I-Intelligence associated with the intelligent ad operating within the web page display and the animation of the intelligent ad is only resumed when the viewability criteria is re-established within the web page (e.g., 50% of the video ad's pixels are visible). Hence, any intelligent ad not completed in a visible form is not registered as an impression indicating completion.

3. Cost per Engagement: This is applicable to rich media ads which have an engagement screen or an additional ad frame which starts to display once the last frame of the original rich-media animation ad is completed as indicated for the cost per completed view. The engagement screen auto expands at the end of the last frame of the original ad, to display details and encourage engagement by the consumer. The expansion of the engagement screen meeting the viewability criteria is recognized by the I-Intelligence associated with the intelligent ad 205 to generate a completion message in the form of a registered impression. The impression count is sent to the advertiser and the publisher to reconcile and enable payment. In this case, the I-Intelligence associated with the intelligent ad is able to recognize when the frames of the animation meet the viewability criteria to enable the ad to continue until the end. If at any point in the intelligent ad display the viewability for a frame goes below the viewability criteria established, the ad display is stopped or halted and resumed only when the viewability for the frame is re-established.

Thus, by adding intelligent component 202 to the ad, the resultant I-Intelligence on the loaded web page and associated with the intelligent ad is able to define when an intelligent ad has been seen by the consumer and enable the advertiser to make the necessary payments for only the intelligent ads that have been seen by the consumer based on the impressions registered indicating meeting of any of the defined payment criteria established between the publisher and the advertiser.

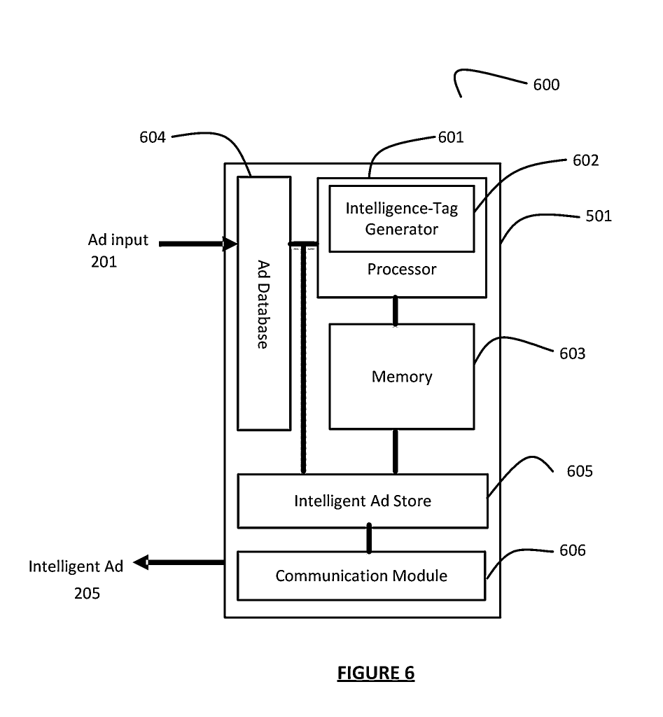

FIG. 6 illustrates an ad modifying server included in the system for the generation of the intelligent ad according to one embodiment of the invention. As shown in FIG. 6, the ad modifier 501 (or ad modifying server) includes a processor for modifying a standard ad 201 into an intelligent ad 205. This is typically done by generating and adding an intelligent component (or intelligent-tag) 202 to the original ad 201 to generate an intelligent ad 205 that when loaded on a web page generates the necessary intelligence (I-Intelligence) to recognize, monitor and measure the viewing of the intelligent ad 205 and provide the registered impression counts to the advertiser for which payment is due when the intelligent ad 205 is inserted for display in a web page 103. The intelligent-tag may be in the form of a script to be run on a web page, a software that may be executed on a processor etc. Referring to FIG. 6, the ad modifying server 501 may include a processor 601, memory storage 603, other dedicated storage and databases 604 and 605, and a communication interface 606. The ad 201 from the advertiser may be received directly or via the communication module 606 of the ad-modifying server 501 and stored in an ad database 604. The processor 601 checks the characteristics of the ad 201 and any viewability criteria provided and defines the intelligent-tag 202 to be generated by the Intelligence-Tag generator 602. The processor 601 modifies the ad 201 by incorporating the intelligence-tag 202 generated by the Intelligence-Tag generator 602 to generate the intelligent ad 205. The generated intelligent ad 205 is saved or stored in the intelligent ad database 605. The ad modifying server 501, on receipt of instructions from the advertiser 402, is able to deliver the appropriate intelligent ad 205 to the publisher 403 using the communication module 606.

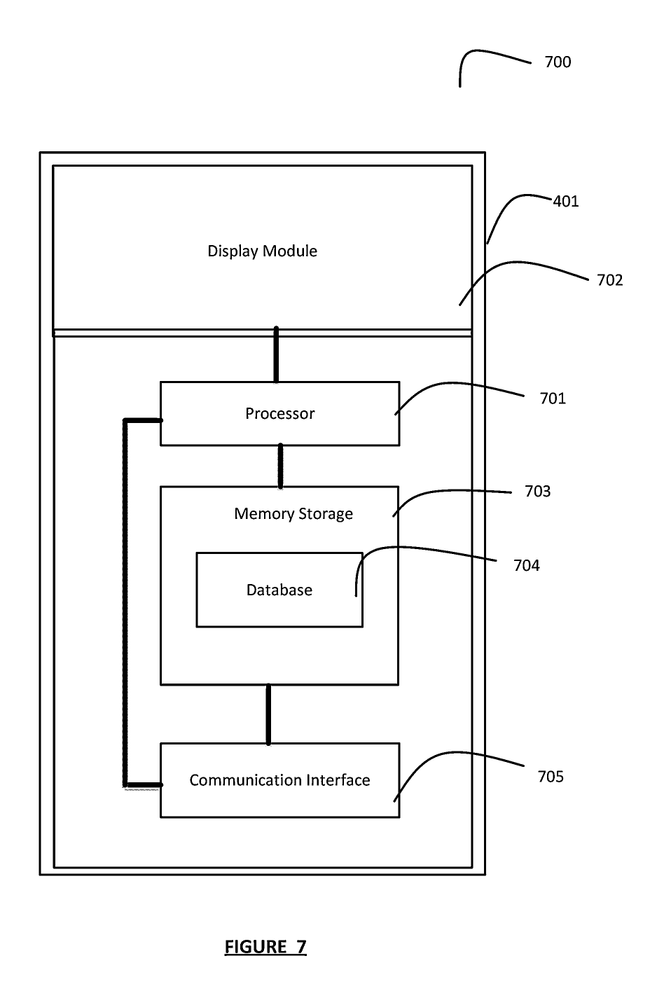

FIG. 7 illustrates a device 401 included in the system to execute the intelligence included in the intelligent ad to ensure that only the executions or displays of the intelligent ad that meet the terms of viewability criteria are counted as impressions according to one embodiment of the invention. The devices 401 may be any display device capable of loading and displaying a web page such as computers and “mobile display device”, laptop, notebook, tablet, and handheld computers or may also take the form of other types of devices, such as mobile telephones, media players, personal data organizers, handheld game platforms, cameras, and/or combinations of such devices. As shown in FIG. 7, the device 401 may include a processor 701, memory storage 703 with one or more databases 704, and a communication interface 705 in addition to the display module having a display screen 702. The device 401 receives the intelligent ad 205 via the communication interface 705 and executes the intelligent-tag 202 included in the intelligent ad 205 during loading and display of the web page that includes the intelligent ad 205. The execution of the intelligent-tag 202, on the web page 103 loaded, enable the incorporated intelligence in the intelligent ad to be instantiated on the web page as I-Intelligence and be associated with the intelligent ad 205. This I-Intelligence is able to provide the capability to identify and register the impressions based on the viewability criteria and payment criteria established and incorporated within the intelligent-tag 202 of the intelligent ad 205.

The communication interface indicated in the embodiments can be a network communication interface that may include a wired network interface such as an IEEE 802.3 Ethernet interface as well as a wireless interface such as an IEEE 802.11 WiFi interface. Data may also be received and sent out using any one of a variety of different wireless communications networks and in accordance with any one of several different protocols. These include: a cellular mobile phone network (e.g. a Global System for Mobile communications, GSM, network), including current 2G, 3G, 4G, and LTE networks; and an IEEE 802.11 network (WiFi or Wireless Local Area Network, WLAN).

Embodiments of the invention may use a machine-readable medium having stored thereon instructions which program the processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

The following embodiments of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a procedure, etc.

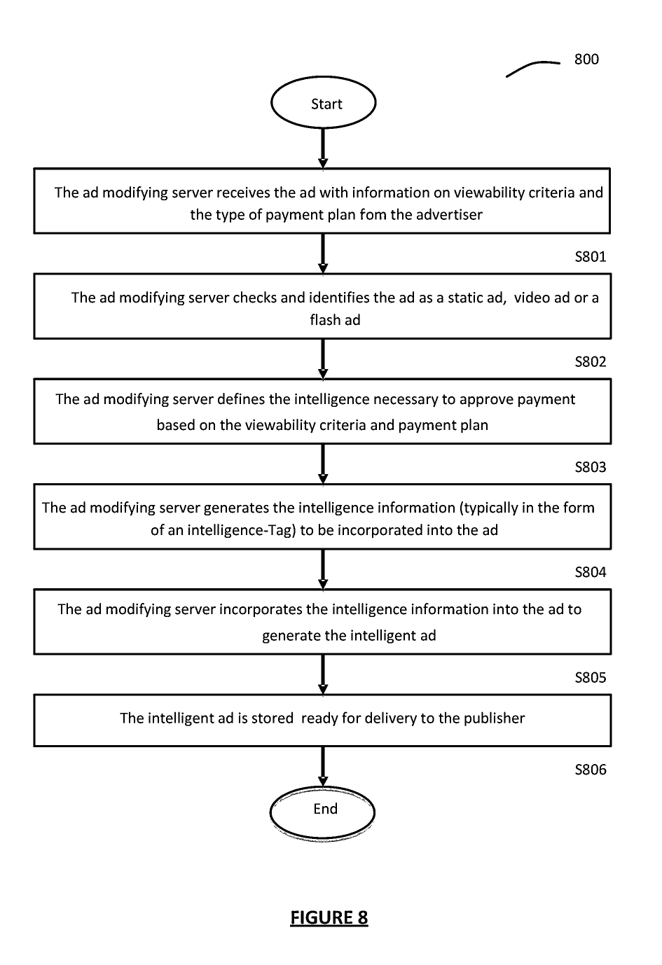

FIG. 8 illustrates a flow diagram of an example method of generating an intelligent ad according to one embodiment of the invention. In a typical case, the advertiser 402 defines the ad campaign and generates ad 201 suitable for the campaign. The ad 402 may be any of a static ad, a video ad or a flash ad or combinations of any of the available ad types. The advertiser 402 also defines the viewability criteria and the payment criteria with the display completion scheme for payment that the advertiser 402 is willing to pay. The viewability criteria may be for example a requirement that at least 50% of the pixels of the ad should be viewed to consider the ad as seen or to consider it as an impression. The payment criteria may be one of cost per ad view, cost per completed view, or cost per engagement.

As shown in FIG. 8, the method 800 starts with the ad modifying server 501 receiving from the advertiser 402 an ad 201 and the details of the viewability criteria and the payment criteria at S801. The ad 201 may be an ad for a campaign that is generated by the advertise 402. At S802, the ad modifying server 501 checks the type of ad provided (e.g., static ad, video ad, flash ad or combination ad). The ad modifying server 501 may also verify the suitability of the ad type to meet the desired payment criteria. At S803, the ad modifying server 501, based on the ad type, the viewability criteria and payment criteria defines the intelligence component 202 to be added to the advertisement 201 to convert it to an intelligent advertisement. At S804, the ad modifying server generates the intelligent component 202 defined in S803. The format of the intelligent component 202 may be in the form of an intelligence-tag 202 that includes at least one of: the viewability requirements, the ad completion requirements, and the registration of impressions for payment requirements, embodied in the viewability criteria or payment criteria.

At S805, the ad-modifying server 501 incorporates the intelligence information, the intelligent component 202 into the ad 201 to modify the ad 201 and generate the intelligent ad 205.

At S806, the ad-modifying server 501 stores the intelligent ad 205 in an the intelligent ad store or database 605. The ad-modifying server 501 may access the intelligent ad 205 from the intelligent ad database 605 and transmit the intelligent ad 205 ready for delivery to the publisher (e.g., during the ad campaign).

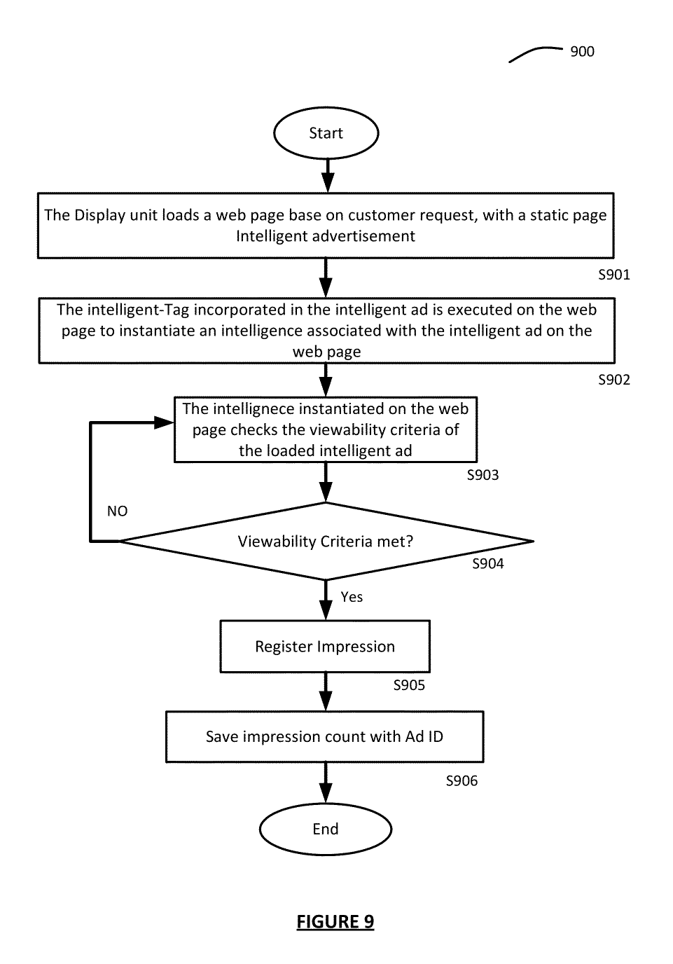

FIG. 9 illustrates a flow diagram of an example method of registering impressions on a loaded web page with an intelligent static ad when payment is based on cost per ad view and providing the registered impressions count according to one embodiment of the invention.

The method 900 starts at S901 with the intelligent ad 205 being received by the publisher 403 and inserted in the web page such that, when the consumer loads the web page for viewing on the device, the intelligent static ad(s) 205 also load on the web page. The intelligent-tag or intelligent component 202, incorporated within the intelligent ad 205 loaded on the web page is executed on the web page, as the page loads, to instantiate an intelligence (I-Intelligence) associated with the intelligent ad 205 on the web page 103. At S902, once the web page is loaded on the display device 401, and the intelligent component 202 (e.g., the intelligent-tag) of the intelligent ad 205 is executed on the loaded web page 103, to instantiate an intelligence (I-Intelligence) on the web page 103 associated with the intelligent ad 205. At S903 the I-Intelligence causes checking of the approved viewability criteria. For instance, if the viewability criteria which is included in the intelligent component 202 is the requirement that a percentage of the ad be visible (e.g., above the fold line 104), the I-Intelligence, that is the intelligence implemented or instantiated on the web page from the intelligent component 202's execution on the web page 103, is enabled to check and identify whether the intelligent ad 205 is above or below the fold line 104 and if the required percentage of the intelligent ad 205 is visible above the fold line 104.

The execution of the intelligent-tag or intelligent component 202, to implement the necessary I-Intelligence on a loaded web page can be done directly on the loaded web page using the capabilities of the web page (preferred mode) using the processing capability of the display device 401 or by the processor 701 of the display device 401 or a combination of the two.

At S903, the I-Intelligence on the web page determines whether viewability requirement is met for the intelligent ad 205 loaded on the web page 103. At S904 if the viewability criteria is not met, the I-Intelligence on the web page continues to check the status of the viewability criteria of the intelligent ad 205 loaded. At S904, if at any time during the period when the web page is loaded (e.g., when the consumer is able to view the webpage), the viewability criteria is met, either as the web page 103 is loaded or by the consumer scrolling down the page during viewing, the I-Intelligence associated with the intelligent ad 205 on the web page recognizes that the viewability criteria has been met and registers an impression indicating that the intelligent ad 205 has been seen by the consumer as indicated at S905. At S906, the I-Intelligence on the web page causes a count of the number of registered impressions over a pre-defined period of time to be accumulated. At S906, the I-Intelligence on the web page also causes the processor 701 of the display device 401 to store the registered impressions count with the identification (ID) of the intelligent ad 205 and to send the registered impressions count with the ID of the intelligent ad 205 to the advertiser 402 and the publisher 403 over a communication channel for payment processing.

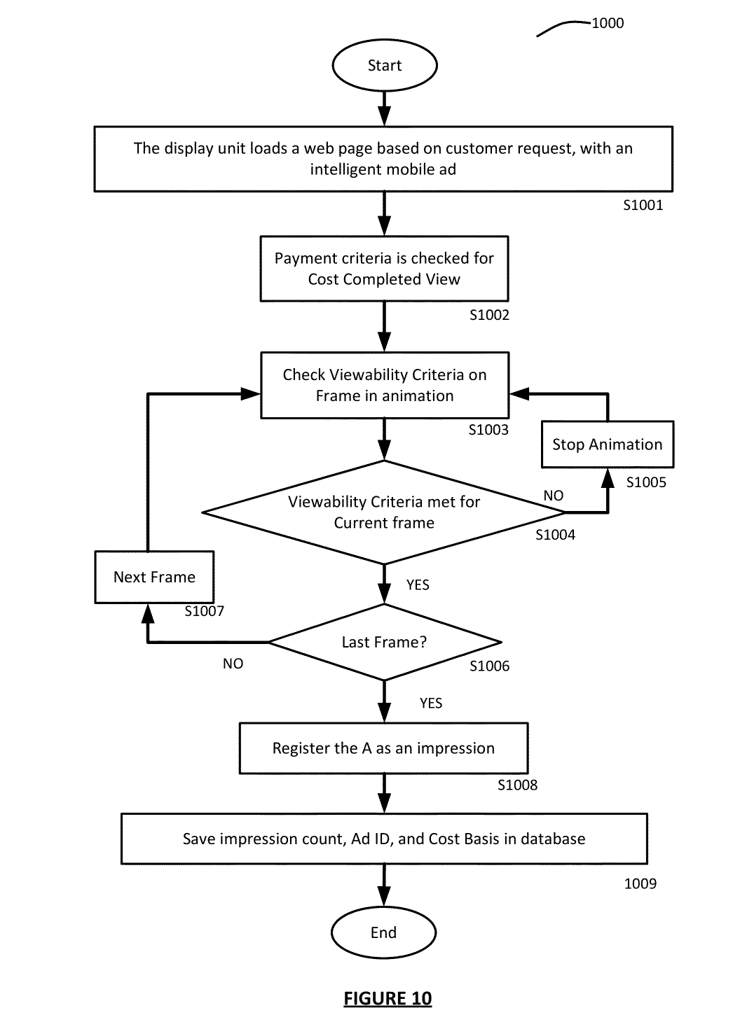

FIG. 10 illustrates a flow diagram of an example method of registering impressions on a loaded web page with an intelligent rich-media mobile ad when payment is based on cost per completed view and providing the registered impressions count according to one embodiment of the invention.

The method 1000 starts at S1001 with the intelligent mobile ad 205 being received by the publisher 403 and inserted in the web page such that, when the consumer loads the web page for viewing on the device 401, the intelligent mobile ad(s) 205 also load on the web page. At S1002, the intelligent-tag or intelligent component 202 associated with the intelligent mobile ad 205 loaded on the web page 103 is executed on the web page 103 as the page loads to instantiate an intelligence (I-Intelligence) associated with the intelligent ad 205 on the web page 103.

The execution of the intelligent-tag or intelligent component 202, to implement and instantiate the intelligence (I-Intelligence) associated with the intelligent ad 205 on a loaded web page 103 can be done directly on the loaded web page using the capabilities instantiated on the web page (preferred mode) using the processing capability of the display device 401 or by the processor 701 of the display device 401 or a combination of the two processing capabilities.

At S1003, the intelligence instantiated (I-Intelligence) implemented by the execution of the intelligent component 202 associated with the intelligent ad 205, executed on the web page 103 loaded on the display device 401 checks the payment criteria for the intelligent mobile ad 205, which is included in the intelligent component 202 and verifies that the payment criteria is cost per completed view. At S1004, the I-Intelligence on the web page 103 causes checking of the viewability criteria included in the intelligent component 202 on each of the animation frame of the intelligent mobile ad 205 on the web page. For instance, if the viewability criteria included in the intelligent component 202 is a requirement that a percentage of the ad be visible (e.g., above the fold line), the I-Intelligence associated with the intelligent mobile ad 205 on the web page 103, checks and identifies whether the intelligent mobile ad 205 is above or below the fold line 104 and if the required percentage of the frame of the intelligent mobile ad 205 is visible above the fold line 104 meeting the viewability criteria for that frame. At S1005, the I-Intelligence on the web page further determines whether viewability requirement is met and if it is not met, the I-Intelligence implemented on the web page further causes the display system to stop the animation of the intelligent ad 205 at S1006. Accordingly, any time the viewability criteria is determined not to be met, the I-Intelligence component associated with the ad 205 does not allow the animation to start or continue. In one embodiment, if the animation is started and running when the I-Intelligence determines that the viewability criteria is no longer met, the animation is stopped at that frame being displayed, which is then held on the display until such time that the viewability is improved and the viewability criteria is met again. If at S1005, the viewability criteria is determined to be met by the I-Intelligence, the method 1000 proceeds to S1007, where the I-Intelligence checks each ad frame displayed to see if the last page or frame has been displayed completing the display of the intelligent mobile ad 205, which indicates that the viewing of the intelligent mobile ad 205 is complete. If at S1007, it is determined that the last page is not completed or the last frame has not been reached, the next frame of the intelligent mobile ad 205 is enabled to start on the web page 103 on the display device 401 as indicated at S1008, so that the animation can continue to display as indicated at S1004 to S1007. If, at S1007, the last frame of the intelligent mobile ad 205 is detected by the I-Intelligence indicating that the intelligent mobile ad 205 has been completely viewed by the consumer, at S1009, the I-Intelligence causes registration of the intelligent mobile ad as an impression. At S1010, the I-Intelligence on the web page 103 causes the processor 701 to establish a count the registered impressions (“registered impressions count”) over a pre-defined period of time. At S1010, the I-Intelligence also causes the processor 701 to store the registered impressions count with the identification (ID) of the intelligent ad 205 and send the registered impressions count with the ID of the intelligent ad 205 to the advertiser 402 and the publisher 403 over a communication channel for payment processing.

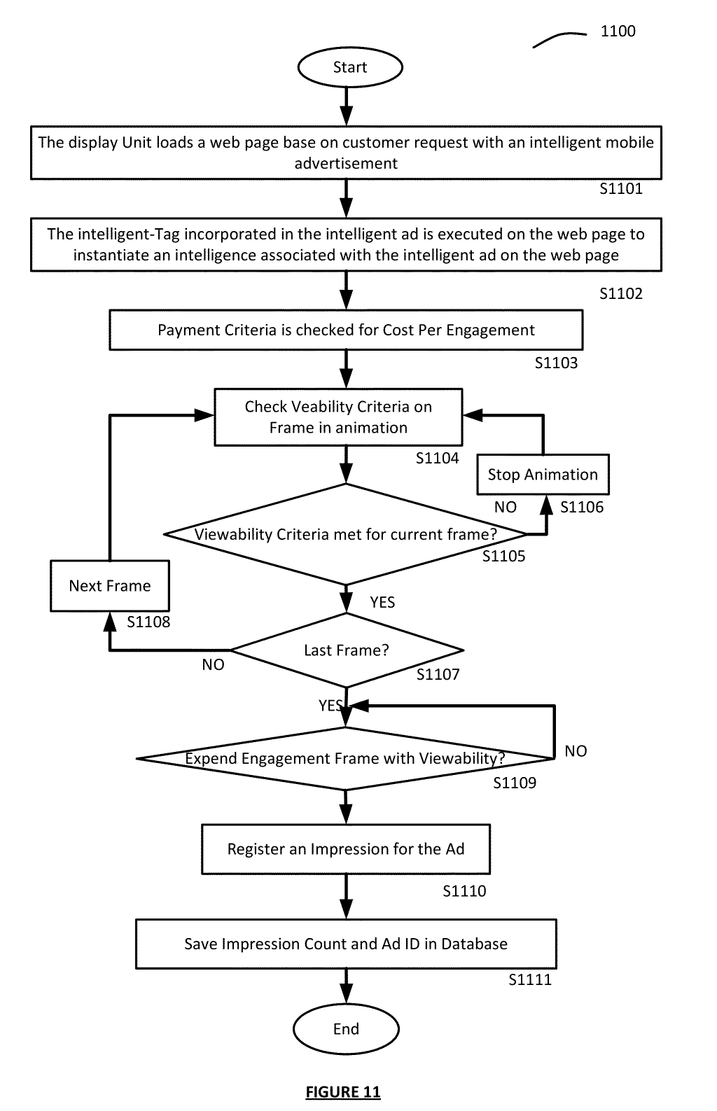

FIG. 11 illustrates a flow diagram of an example method of registering impressions on a loaded web page with an intelligent rich-media mobile ad when payment is based on cost per engagement and providing the registered impressions count according to one embodiment of the invention. An engagement screen opens after the ad has completed animation to allow the consumer to engage with the ad. The payment in the case of cost per engagement is not based on the ad completion but on the engagement screen being presented to the consumer. In this embodiment, the intelligent component 202 being executed on the web page 103 being loaded on the display terminal 401 accounts for this payment criteria.

The method 1100 starts at S1101 with the intelligent mobile ad 205 being received by the publisher 403 and inserted in the web page such that, when the consumer loads the web page for viewing on the device 401, the intelligent mobile ad(s) 205 also load on the web page. The intelligent-tag or intelligent component 202 associated with the intelligent mobile ad 205 loaded on the web page 103 is executed on the web page 103 as the web page loads.

The execution of the intelligent-tag or intelligent component 202, to implement or instantiate the necessary intelligence on a loaded web page can be done directly presented to the consumer. In this embodiment, the intelligent component 202 being executed accounts for this payment criteria. The method 1100 starts at S1101 with the intelligent mobile ad 205 being received by the publisher 403 and inserted in the web page such that, when the consumer loads the web page for viewing on the device 401, the intelligent mobile ad(s) 205 also load on the web page. The intelligent-tag or intelligent component 202 associated with the intelligent mobile ad 205 loaded on the web page 103 is executed on the web page 103 as the web page loads.

The execution of the intelligent-tag or intelligent component 202, can be done directly on the loaded web page using the capabilities instantiated on the web page (preferred mode) using the processing capability of the display of the device 401 or by the processor 701 of the display device 401 or a combination of the two.

At 1102 the intelligence component implemented on the web page 103 from the intelligent component 202 executed on the web page 103 loaded on the display device 401 to instantiate an intelligence (I-Intelligence) on the web page 103. At S1103 the I-Intelligence enable checking of the payment criteria for the intelligent mobile ad 205, which may be included in the intelligent component 202 and verifies that the payment criteria is cost per engagement. At S1104, the I-Intelligence associated with the intelligent mobile ad 205 implemented on the web page 103 from the intelligent-tag or intelligent component 202 loaded and executed on the web page 103 causes checking of the viewability criteria included in the intelligent component 202 on each of the animation frame of the intelligent mobile ad 205 on the web page. For instance, if the viewability criteria which may be included in the intelligent component 202 is a requirement that a percentage of the ad be visible (e.g., above the fold line), the I-Intelligence on the web page 103 checks and identifies whether the intelligent mobile ad 205 is above or below the fold line 104 and if the required percentage of the frame of the intelligent mobile ad 205 is visible above the fold line 104 meeting the viewability criteria for that frame. At S1106, the I-Intelligence on the web page 103 determines whether viewability requirement is met and if it is not met, the I-Intelligence on the web page further causes the display system to stop the animation of the intelligent ad 205 at S1106. Accordingly, any time the viewability criteria is determined not to be met, the I-Intelligence implemented on the web page does not allow the animation of the intelligent mobile ad 205 to start or continue. In one embodiment, if the animation is started and running when the I-Intelligence on the web page 103 determines that the viewability criteria is no longer met, the animation is stopped at that frame being displayed, which is then held on the display until such time that the viewability is improved and the viewability criteria is met again. If at S1105, the viewability criteria is determined to be met by the I-Intelligence on the web page 103, the method 1100 proceeds to S1107, where the I-Intelligence associated with the intelligent mobile ad 205, implemented on the web page 103, checks the ad frame displayed to see if the last page or last frame display has been completed, which indicates that the viewing of the intelligent mobile ad 205 is complete. If at S1007, the I-Intelligence on the web page determines that the last page is not completed or the last frame has not been reached, the next frame of the intelligent mobile ad 205 is enabled as at S1108 to start on the web page 103 on the display device 401, so that the animation can continue to display as discussed at S1104 to S1107 till the last frame is displayed. If, at S1107, the last frame of the intelligent mobile ad 205 is detected such that the intelligent mobile ad 205 has been completely viewed by the consumer, at S1107, the I-Intelligence causes the triggering or an expansion of an engagement screen, which may be a static or mobile screen giving the consumer an opportunity to interact with the engagement screen. The expanded engagement screen itself is also provided by the advertiser as a part of the intelligent mobile advertisement.

If, at S1109, the engagement screen does not expand or it does not expand in a viewable fashion (e.g., the expanded engagement screen does not meet the viewability criteria), the method 1100 stops any animation and waits until the viewability criteria for the expanded screen is determined to be met or re-established. If, at S1109, the engagement screen is expanded in a viewable fashion (e.g., the expanded engagement screen meets the viewability criteria) such that it indicates completion of the ad viewing, the method 1100 then proceeds to S1110 where the intelligent component 202 causes the processor 701 to recognize completion of the intelligent mobile ad 205 and registers an impression.

At S1111, the I-Intelligence causes the processor 701 to count the registered impressions (“registered impressions count”) over a pre-defined period of time. At S1111, I-Intelligence also causes the processor 701 to store the registered impressions count for each intelligent mobile ad 205 with the identification (ID) of the intelligent mobile ad 205. This registered impressions count with the ID of the intelligent ad 205 is sent by the Display device 40, to the advertiser 402 and the publisher 403 over a communication channel for payment processing.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

1. A method of generating intelligent advertisements comprising:
receiving an advertisement (“ad”), a viewability criteria associated with the ad and a payment criteria associated with the ad;
defining and generating an intelligent component based on a type of ad associated with the ad, the viewability criteria, and the payment criteria; and
incorporating the intelligent component into the ad to generate an intelligent ad,
wherein the intelligent component includes instructions that when executed on a web page loaded on a display device, causes an instantiation of an intelligence associated with the intelligent ad that enables registration of an impression of the intelligent ad only when the viewability criteria is met.

2. The method of claim 1 further comprising:
determining a type of ad associated with the ad received, wherein the type of ad includes at least one of static ad, video ad, or flash ad.

3. The method of claim 1 wherein the payment criteria is at least one of: cost per ad view, cost per completed view, or cost per engagement.

4. The method of claim 1, wherein the viewability criteria is met when a predetermined percentage of pixels of the intelligent ad are displayed on a display device.

5. The method of claim 4, wherein the intelligent component includes instructions that when executed by the processor, causes the processor to:
stop animation of the intelligent ad when the viewability criteria is not met, wherein the intelligent ad is one of a video or a flash ad.

6. The method of claim 4, wherein the intelligent component includes instructions that when executed on the webpage, causes instantiation of the intelligence associated with the intelligent ad that further enables:
determining that a last frame of the intelligent ad is displayed, and
registering an impression of the intelligent ad only when the last frame of the intelligent ad is determined to be displayed, wherein the intelligent ad is one of a video or a flash ad.

7. The method of claim 4, wherein the intelligent component includes instructions that when executed on the webpage, causes the instantiation of the intelligence associated with the intelligent ad that further enables:
determining that a last frame of the intelligent ad is not displayed, and
displaying a next frame of the intelligent ad, wherein the intelligent ad is one of a video or a flash ad.

8. The method of claim 6, wherein the intelligent component includes instructions that when executed on the webpage, causes the instantiation of the intelligence associated with the intelligent ad that further enables:
triggering an expansion of an engagement screen associated with the intelligent ad, and
registering an impression of the intelligent ad only when the processor determines that the expanded engagement screen meets the viewability criteria.

9. The method of claim 8, wherein the intelligent component includes instructions that when executed on the webpage, causes the instantiation of the intelligence associated with the intelligent ad that further enables:
stopping animation of the intelligent ad when the expanded engagement screen is determined not to meet the viewability criteria.

10. The method of claim 8, wherein the intelligent component includes instructions that when executed on the webpage, causes the instantiation of the intelligence associated with the intelligent ad that further enables:
counting a number of registered impressions of the intelligent ad over a period of time,
associate the number of registered impression of the intelligent ad with an identification (“ID”) of the intelligent ad, and
transmitting the number of registered impressions of the intelligent ad with the ID of the intelligent ad to an external server.

11. The method of claim 1, wherein the instructions included in the intelligent component are executed on the webpage, causes the instantiation of the intelligence associated with the intelligent ad that further enables the web page including the intelligent ad to be loaded on the display device.

12. An apparatus for generating intelligent advertisements comprising:
an communication module
to receive an advertisement (“ad”), a viewability criteria associated with the ad, and a payment criteria associated with the ad,
to transmit an intelligent ad to an external device; and
a first processor
determine a type of ad associated with the ad received, wherein the type of ad includes at least one of static ad, video ad, or flash ad,
to define and generate an intelligent component based on the type of ad associated with the ad, the viewability criteria, and the payment criteria, and
incorporating the intelligent component into the ad to generate the intelligent ad,
wherein the intelligent component includes instructions that when executed on a webpage loaded on an external display device, causes an instantiation of an intelligence associated with the intelligent ad that enables registration of an impression of the intelligent ad only when the viewability criteria is met.

13. The apparatus of claim 12, wherein the instructions included in the intelligent component are executed on the webpage, causes the instantiation of the intelligence associated with the intelligent ad that further enables the web page including the intelligent ad to be loaded on the external display device.

14. The apparatus of claim 12, wherein the viewability criteria is met when a predetermined percentage of pixels of the intelligent ad are displayed by a second processor on the external display device, the second processor being included in the external display device.

15. The apparatus of claim 14, wherein the intelligent component includes instructions that when executed on the webpage, causes the instantiation of the intelligence associated with the intelligent ad that further enables:
stopping animation of the intelligent ad when the viewability criteria is not met, wherein the intelligent ad is one of a video or a flash ad.

16. The apparatus of claim 14, wherein the intelligent component includes instructions that when executed on the webpage, causes the instantiation of the intelligence associated with the intelligent ad that further enables:
determining that a last frame of the intelligent ad is displayed, and
registering an impression of the intelligent ad only when the last frame of the intelligent ad is determined to be displayed, wherein the intelligent ad is one of a video or a flash ad.

17. The apparatus of claim 14, wherein the intelligent component includes instructions that when executed on the webpage, causes the instantiation of the intelligence associated with the intelligent ad that further enables:
determining that a last frame of the intelligent ad is not displayed, and
displaying a next frame of the intelligent ad, wherein the intelligent ad is one of a video or a flash ad.

18. The apparatus of claim 16, wherein the intelligent component includes instructions that when executed on the webpage, causes the instantiation of the intelligence associated with the intelligent ad that further enables:
triggering an expansion of an engagement screen associated with the intelligent ad, and
registering an impression of the intelligent ad only when the expanded engagement screen is determined to meet the viewability criteria.

19. The apparatus of claim 18, wherein the intelligent component includes instructions that when executed on the webpage, causes the instantiation of the intelligence associated with the intelligent ad that further enables:
stopping animation of the intelligent ad when the expanded engagement screen is determined not to meet the viewability criteria.

20. The apparatus of claim 18, wherein the intelligent component includes instructions that when executed on the webpage, causes the instantiation of the intelligence associated with the intelligent ad that further enables:
counting a number of registered impressions of the intelligent ad over a period of time,
associate the number of registered impression of the intelligent ad with an identification (“ID”) of the intelligent ad, and
transmitting the number of registered impression of the intelligent ad with the ID of the intelligent ad to an external server.
